(19) United States
(12) Patent Application Publication
(10) Pub. No.: US 2007/0089939 A1
(43) Pub. Date: Apr. 26, 2007

(54) Control Panel for an Elevator, and Elevator with such a Control Panel

(75) Inventor: Christoph Liebetrau, Menziken (CH)

Correspondence Address: BUTZEL LONG, STONERIDGE WEST, 41000 WOODWARD AVENUE, BLOOMFIELD HILLS, MI, 48304, US

(73) Assignee: INVENTIO AG, Hergiswil (CH)

(21) Appl. No.: 11/553,047

(22) Filed: Oct. 26, 2006

(30) Foreign Application Priority Data
Oct. 26, 2005 (EP) 05110006.3

(51) Int. Cl. B66B 1/34

(52) U.S. Cl. 187/395

(57) ABSTRACT

A control panel for an elevator has at least one pressure-sensitive action field in order to trigger an action by pressing. The control panel has a layered construction with a top plate, a base plate and a piezo element. An opening is provided in the top plate to define the action field. The piezo element is seated in the region of the opening between the top plate and the base plate so that by pressing in the region of the action field a force can be exerted on the piezo element and the piezo element delivers an electrical output signal to an electronic circuit. The electronic circuit provides an electrical acknowledgement signal in order to produce a change recognizable at the control panel as an acknowledgement.

### BACKGROUND OF THE INVENTION

The present invention relates to control panels for elevators, and to correspondingly equipped elevators.

Control panels, also called indicator boards, are used particularly in elevator installations. These control panels must correspond with a great number, in part contradictory, of requirements. On the one hand they should be functionally reliable and on the other hand it is expected that they are economic. Today, aesthetics also increasingly play an important role. The control panels thus have to be visually pleasing and they shall be adaptable to the design of the elevator. It is particularly important for the control panels to be flat.

Ideally the control panel is designed so that it is substantially independent of the substructure of an elevator car or shaft wall.

Moreover, such control panels have to be hygienic and readily able to be cleaned. In addition, security against vandalism has increasing significance in publicly accessible areas. Furthermore, control panels should be appropriate for use by handicapped persons and fulfil legal standards.

It is clear from these remarks that it is possible to do justice to all these demands only with difficulty.

Control panels with pressure switches, press buttons with switching pads, with capacitive sensors, with infrared sensors or with piezo sensors are generally known, to mention only some examples.

There are press button boards, membrane keyboards, glass panels and numerous other variants of control panels. These control panels, however, fulfil only some of the mentioned requirements.

### SUMMARY OF THE INVENTION

It is therefore an object of the present invention to develop a control panel especially for use in an elevator, which does justice to the requirements stated in the introduction.

According to the present invention this object is fulfilled by a control panel for an elevator, wherein the control panel has at least one pressure-sensitive action field in order to trigger an action through pressing, characterized in that the control panel has a layered construction with a top plate, a base plate and a piezo element, wherein a marking is provided in the top plate in order to define the action field, wherein the piezo element is so arranged in the region of the marking between the top plate and the base plate that through pressing in the region of the action field a force can be exerted on the piezo element and the piezo element delivers an electrical output signal to an electronic circuit, and wherein the electronic circuit provides an electrical acknowledgement signal in order to cause a change recognizable at the control panel as acknowledgement.

Such a control panel has the advantages that through the flat and closed layered construction it is economic, functionally reliable and visually pleasing.

According to the present invention the object is fulfilled, for an elevator, by a control panel wherein the control panel is preferably arranged in or at an elevator car of the elevator.

Such an elevator has the advantages that through the flat and closed layered construction of the control panel it is secure against vandalism and has an adaptable design.

The control panel according to the present invention comprises an electronic circuit which acts by the acknowledgement signal on the piezo element as acknowledgement in order to produce a change of the piezo element which is detectable in the action field. This form of embodiment has the advantage that the control panel is appropriate to handicapped persons, because even blind passengers can discern, by the acknowledgement, a confirmation that an elevator call has been registered.

In the control panel according to the present invention there is arranged in the region of the action field a pressure element which protects the piezo element and the underlying electronic circuits and offers a pleasing and risk-free tactile sensation for the fingers of the passengers.

In the control panel according to the present invention the pressure element is a substantially cylindrical pressure element which is seated in the marking and acts by a rear side directly or indirectly on the piezo element when the pressure element is pressed, so that the transmission of the finger force is direct and safe from error.

In the control panel according to the present invention the layered construction comprises a film, preferably an adhesive film, in order to fix the piezo element. Such a control panel has the advantages that it can be very thin and that fastening of the piezo element is very simple, economic and uncomplicated.

In the control panel according to the present invention the layered construction comprises a film, preferably a PVB film, or a cast resin layer, which are usual practical economic materials for such use.

In the control panel according to the present invention the layered construction comprises a film with at least one integrated light-emitting diode and the light-emitting diode delivers light through the top plate when it is acted on by the acknowledgement signal. Such a control panel has the advantages that a visual acknowledgement signal is also generated which can also be sensed by inattentive passengers with insensitive fingers.

In the control panel according to the present invention the foil comprises conductor tracks, preferably transparent conductor tracks, so as to be able to connect the light-emitting diode with the circuit. The construction is thereby very compact and aesthetically pleasing.

In the control panel according to the present invention the top layer consists of glass, which is transparent.

In the control panel according to the present invention the piezo element is vapor deposited on or glued to a carrier layer. Very thin piezo elements can be produced by this production method.

In the control panel according to the present invention several action fields are provided and a piezo element is associated with each action field and connectable with the circuit, so that different piezo elements correspond with calls to different floors.

In the elevator according to the present invention an electrical circuit is present in order to receive and process the electrical output signal and in order to provide the acknowledgement signal. The elevator installation is thus capable of allocating an elevator call to a specific floor in dependence on the piezo element which is pressed.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is an exploded schematic sectional view of a first control panel according to the present invention, wherein the individual components are shown before being joined together;

FIG. 2A is an exploded schematic sectional view of a second control panel according to the present invention, wherein the individual components are shown before being joined together;

FIG. 2B is a schematic plan view of the second control panel according to the present invention;

FIG. 3 is an exploded schematic sectional view of a third control panel according to the present invention, wherein the individual components are shown before being joined together;

FIG. 4 is an exploded schematic sectional view of a fourth control panel according to the present invention, wherein the individual components are shown before being joined together;

FIG. 5A is a schematic sectional view of an upper part of a fifth control panel according to the present invention;

FIG. 5B is a schematic sectional view of an upper part of a sixth control panel according to the present invention;

FIG. 6A is an exploded schematic sectional view of a seventh control panel according to the present invention, wherein the individual components are shown before being joined together; and

FIG. 6B is a schematic plan view of the seventh control panel according to the present invention.

### DESCRIPTION OF THE PREFERRED EMBODIMENT

Identical and similar components and components that have the same effect are provided in all figures with the same reference numerals.

According to the present invention a piezo element 13 is used, which serves as a pressure sensor converting a mechanical actuation into an electrical signal. Different embodiments of the present invention are shown in the figures. According to the invention the small and thin piezo element 13 is arranged in the region of a so-termed action field 16, wherein it can be actuated by a user of the elevator installation by exertion of a pressure force. The piezo element 13 is preferably arranged coaxially below the action field 16.

Piezo elements 13 are particularly suitable, since on the one hand as a pressure element they are in a position of producing an electrical signal by a force directed longitudinally. On the other hand, a piezo element 13 when it is acted on by a corresponding acknowledgement signal can produce a force or movement in an opposite longitudinal direction. As a result, by contrast to other actuators, the behavior of a conventional press button can be simulated. Some of the forms of embodiment described in the following make use of this “mechanical feedback”.

A feedback is particularly important for users of an elevator which have poor eyesight or are blind. However, a clear and plain acknowledgement can also be very important for elderly users or persons with handicaps.

The control panel according to the present invention can deliver tactile (mechanical feedback) and/or optical and/or acoustic acknowledgements to the user.

In order to deliver tactile acknowledgements (mechanical feedback) the piezo element 13 can, as already indicated, serve as a mechanical actuator, which, triggered by an acknowledgement signal, triggers a reaction (for example, a vibration or a deformation).

The piezo element 13 can alternatively or additionally also serve as a piezo loudspeaker, which, through an acknowledgement signal directed in the appropriate frequency, generates soundwaves which are audible.

The piezo element 13 can alternatively or additionally also be equipped with an optical feedback as is described later.

Moreover, a control panel 10 with several switches or buttons has to be in a position of distinguishing intentional actuation of one of the switches or buttons from unintentional contact. Here, too, the piezo element 13 offers significant advantages relative to so many conventional touch-sensitive sensor buttons, since only a sufficient force acting in longitudinal direction triggers an electrical signal with high voltage.

A further significant point of the invention is the integration of the necessary elements in the control panel 10 which is as thin as possible and flexibly usable.

Monolithic (sintered) piezo elements 13 (LVPZT), which are produced in a process similar to ceramic capacitors from several ceramic layers, are therefore particularly suitable. This form of piezo element 13 is particularly well suited to integration in a thin layered construction according to the present invention. Such monolithic piezo elements 13 are also termed low-voltage piezoactuators. The ceramic layers typically have a thickness of 20 to 100 microns. Such low-voltage piezo elements 13 have, by comparison with other piezo elements, the advantage that voltages of less than 100 volts are sufficient in order to generate a mechanical deformation as a mechanical acknowledgement.

Instead of the monolithic piezo elements 13 use can also be made of piezoelectric polymer films (PVDF polymer or co-polymer) as the piezo elements 13. The thickness of such piezoelectric polymer films is below 1,000 microns and preferably between 10 and 200 microns. Piezoelectric polymer films react very sensitively to mechanical pressure and are therefore particularly well suited for use in the control panel 10 according to the present invention. The conversion of an acknowledgement signal into a deformation is, however, less strongly pronounced than in the case of other piezos.

It is a further advantage of the piezo elements 13 relative to many other switches and buttons that they have an extremely high service life.

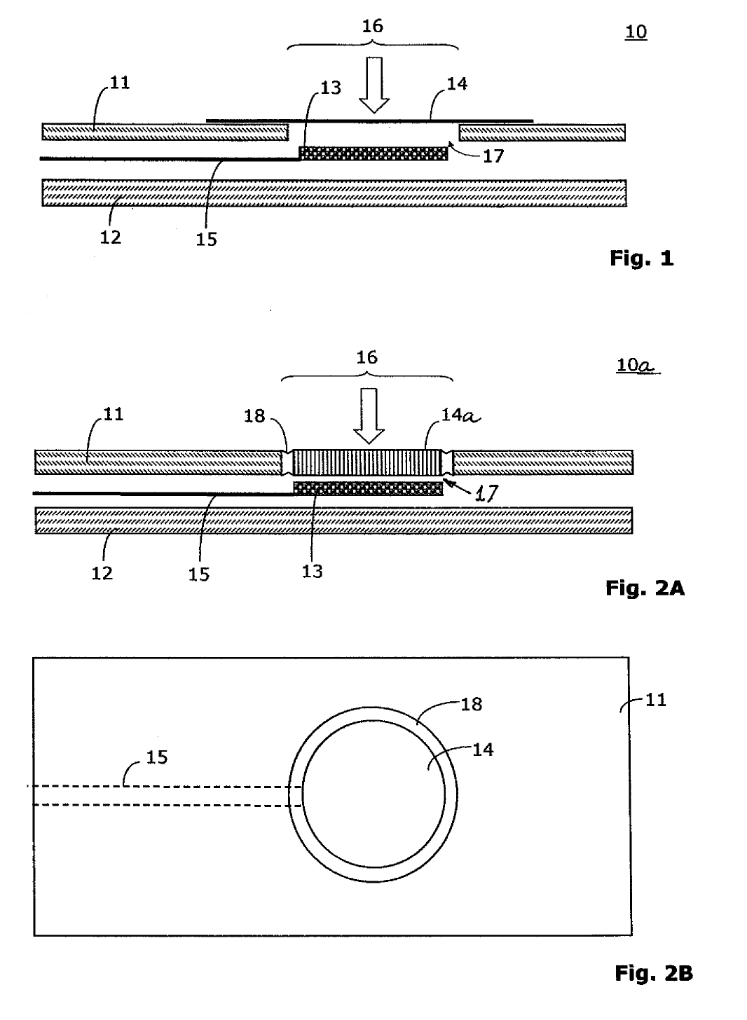

Further details of a first embodiment of the present invention are now described with reference to FIG. 1. The control panel 10 designed especially for installation in an elevator is shown. The control panel 10 comprises at least one pressure-sensitive action field 16 in order to be able to trigger an action by pressing. In the figures the pressing or actuation is clarified on each occasion by a block arrow.

According to the present invention the control panel 10 has a layered construction at least with a top plate 11, a base plate 12 and the piezo element 13. In FIG. 1 these elements are shown prior to being joined together. The top plate 11 is provided with a marking 17 in the form of an opening so as to define the action field 16. The piezo element 13 is so arranged in the region of the opening 17 between the top plate 11 and the base plate 12 that through pressing in the region of the action field 16 a force is exerted on the piezo element 13. The piezo element 13 converts this pressure force into an electrical output signal and delivers this to an electronic control circuit. The circuit is shown only in FIG. 6A, since it is not significant to the construction of the control panel and there are numerous possibilities for realizing such a circuit.

According to the present invention the electronic control circuit is so designed that on the one hand it can process the output signal in order to trigger an action (for example, the calling of an elevator car) and in order on the other hand to provide an electrical acknowledgement signal so as to produce a change recognizable at the control panel 10 as the acknowledgement. Such an acknowledgement is, as described further above, an important element.

Moreover, it can be recognized in FIG. 1 that the opening 17 is covered or occupied by a film or protective cap, which is here termed a pressure element 14. Film and protective cap are provided with, for example, numbers, letters or characters in order to represent floors. In addition, Braille characters can be applied to the film or protective cap in order to assist blind passengers to recognize the floors. The piezo element 13 is connected with the circuit by way of lines 15. These lines are preferably arranged between the layers of the layered construction. They can be cables or wires, or lines can be used which are integrated on or in one of the layers (for example, by vapor deposition). The top plate 11 can also cover the piezo element 13 and the pressure element 14 in this case consists of the part of the top plate 11 lying above the piezo element 13. If this part of the top plate 11 is pressed, elevator calls are correspondingly input.

Some details with respect to materials used, which are particularly preferred, are given in the following. The base plate 12 and the cover plate 11 can be made of glass, plastic or metal or another material. Glass is particularly preferred. Ceramic multi-layer piezo elements or piezo elements of piezoelectric polymer films are particularly suitable. Transparent conductor tracks are particularly preferred as the lines 15 if the control panel 10 should be constructed to be transparent (for example, if the top plate 11 is of glass). The piezo element 13 is preferably bonded or glued to the base plate. Forms of the embodiment are particularly preferred in which use is made of a film comprising several piezo elements 13. A thin film can be used as the pressure element 14, which film should be tear-resistant and flexible. The pressure elements can be fastened by bonding, gluing or mechanically positive coupling. Several pressure elements can be fastened as a composite.

A second embodiment is shown in FIGS. 2A and 2B. The illustrated control panel 10a has, analogously to FIG. 1, a layered construction at least with the top plate 11, the base plate 12 and the piezo element 13. These elements are shown prior to being joined together. The top plate is provided with the marking 17 in order to define the action field 16. The piezo element 13 is so arranged in the region of the opening 17 between the top plate 11 and the base plate 12 that through pressing in the region of the action field 16 a force is exerted on the piezo element 13. The piezo element 13 converts this pressure force into an electrical output signal and delivers this to an electronic circuit.

In this embodiment a press button is used as a pressure element 14a. This press button can be, for example, a cylindrical element made of glass. Between the pressure element and the top plate the joint is filled by a form of a joint seal 18. A silicon-like flexible material is preferably used as the joint seal 18. It is important that this material on the one hand so fixes the pressure element so that a displacement in the longitudinal direction is possible and that on the other hand the joint seal 18 prevents dust, dirt or moisture from penetrating into the layers of the control panel.

In FIG. 2B it can be seen that the pressure element 14a has a circular cross-section and that the joint seal 18 surrounds the pressure element 14a. Moreover, there is indicated in FIG. 2B the course of two lines 15 which lead to a circuit (not shown).

A third embodiment is shown in FIG. 3. The illustrated control panel 10b has, analogously to FIG. 1, a layered construction at least with the top plate 11, the base plate 12 and the piezo element 13. Moreover, seated below the piezo element 13 is an adhesive film 19. A film 20 is provided on the base plate. These elements are shown prior to being joined together. The top plate 11 is provided with an opening 17 in order to define the action field 16. The piezo element 13 is so arranged in the region of the opening 17 between the top plate and the base plate 12 that through pressing in the region of the action field 16 a force is exerted on the piezo element 13. The piezo element 13 converts this pressure force into an electrical output signal and delivers this to an electronic circuit.

As in the case of the second embodiment, in this embodiment as well a press button is used as the pressure element 14a. This press button can be, for example, a cylindrical element made of glass. Between the pressure element and the top plate the joint is filled by the joint seal 18. The lower adhesive film 19 can be used in order to fix the piezo element 13 and/or to insulate it relative to the base plate 12.

The film 20 can be, for example, a polyvinylbutyral (PVB) film such as is currently used in compound safety glass. The layered construction thus gains significantly more stability and in the case of damage it does not disintegrate into its individual parts. However, the film 20 can also be arranged at another position of the layered construction.

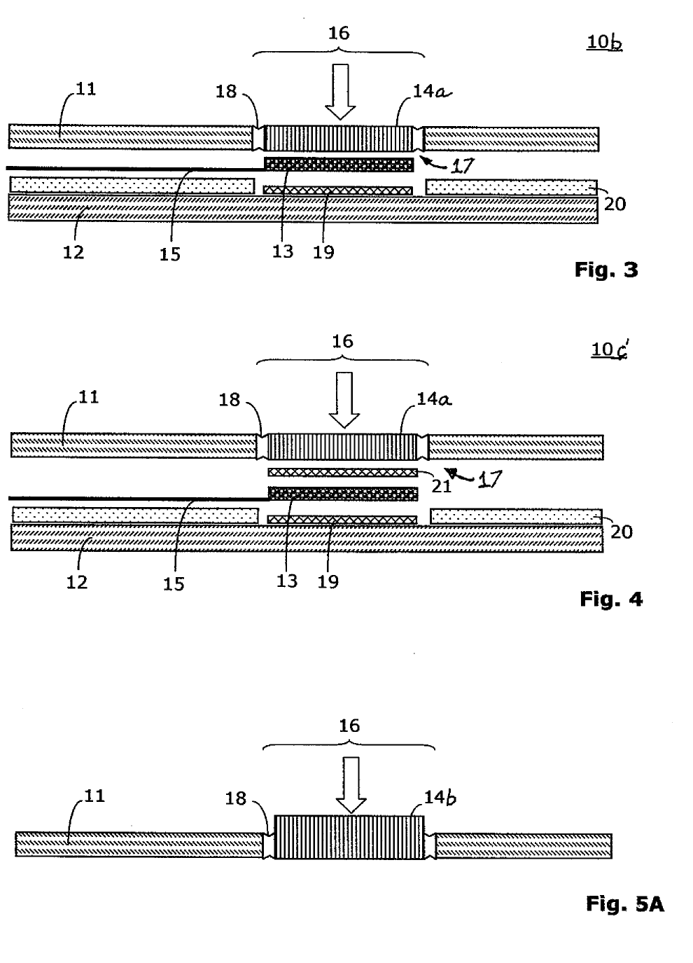

A fourth embodiment is shown in FIG. 4. The illustrated control panel 10c has, analogously to FIG. 1, a layered construction at least with the top plate 11, the base plate 12 and the piezo element 13. In addition, respectively seated below and above the piezo element 13 are the adhesive film 19 and an adhesive film 21. The film 20 is provided on the base plate. These elements are shown before being joined together. The top plate 11 is provided with the opening 17 in order to define the action field 16. The piezo element 13 is so arranged in the region of the opening 17 between the top plate 11 and the base plate 12 that through pressing in the region of the action field 16 a force is exerted on the piezo element 13. The piezo element 13 converts this pressure force into an electrical output signal and delivers this to an electronic circuit.

As in the case of the second or third embodiment the press button 14a is also used in this embodiment as the pressure element. This press button can be, for example, a cylindrical element made of glass. Between the pressure element and the top plate the joint is filled by the joint seal 18.

The upper adhesive film 21 can, for example, be structure or printed in order to mark or designate the action field 16. A numeral or a letter can, for example, be shown on this film 21. This numeral or letter is then visible to the user from the outside through the pressure element 14a. The lower adhesive film 19 can again be used in order to fix the piezo element 13 and/or to insulate it relative to the base plate 12.

The film 20 can be, for example, a polyvinylbutyral (PVB), as described in connection with FIG. 3.

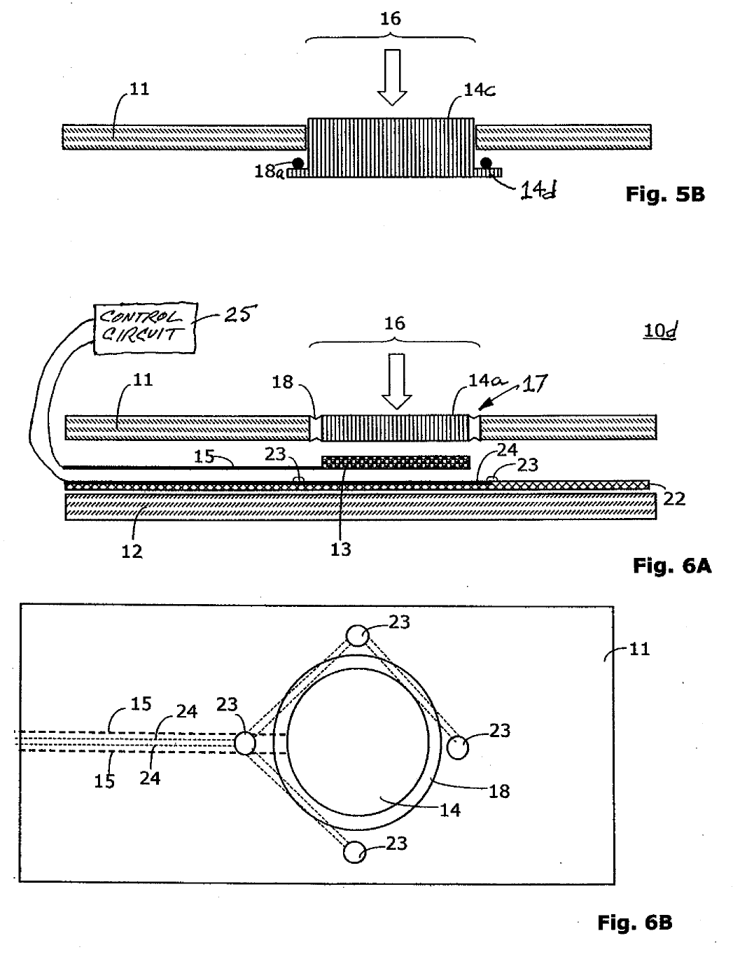

An upper region of a further embodiment is shown in FIG. 5a. The illustrated embodiment differs from the second, third and fourth embodiments in that a pressure element 14b is elevated. An upper region of the pressure element 14b thereby protrudes from the top plate 11 and is easier to detect. The remaining elements of the control panel can be constructed as shown in FIGS. 1 to 4.

An upper region of a further embodiment is shown in FIG. 5B. The illustrated embodiment differs from the second, third and fourth embodiments in that a pressure element 14c is elevated. An upper region of the pressure element 14c thereby protrudes from the top plate 11 and is more easily detected. Moreover, the pressure element 14c has an encircling collar or flange 14d having a diameter which is greater than the diameter of the opening 17. If the pressure element is inserted from behind through the top plate, then it can not drop out towards the front or be removed with force. The encircling collar 14d can also have even a further function, as indicated in FIG. 5B. It can carry a sealing/spring ring 18a. The remaining elements of the control panel can be constructed as shown in FIGS. 1 to 4.

A further embodiment is shown in FIGS. 6A and 6B. The illustrated control panel 10d has, analogously to FIG. 1, a layered construction at least with the top plate 11, the base plate 12 and the piezo element 13. Moreover, a film 22 is provided which has at least one integrated or adhered light-emitting diode 23. These elements are shown before being joined together. The top plate 11 is provided with the opening 17 in order to define the action field 16. The piezo element 13 is so arranged in the region of the opening 17 between the top plate 11 and the base plate 12 that through pressing in the region of the action field 16 a force is exerted on the piezo element 13. The piezo element 13 converts this pressure force into an electrical output signal and delivers this to an electronic circuit. The light-emitting diodes 23 are arranged near the piezo element 13. The arrangement was so selected that the light-emitting diodes 23 are visible from outside either through the pressure element 14a or through the top plate 11. The light-emitting diodes 23 are acted on by a voltage via lines 24. The lines 15 and the lines 24 are connected to a control circuit 25 that receives the output signal from the piezo element 13 and generates the acknowledgment signal. The control circuit 25 also can be used with the control panels 10, 10a, 10b, 10c wherein the acknowledgment signal is generated on the lines 15.

The light-emitting diodes 23 which have a low heat output, a high service life expectation and a very flat mode of construction are inserted in or on the film 22. Ideally the film 22 together with the light-emitting diodes 23 is inserted between two PVB films.

The light-emitting diodes 23 with different colors can be used.

It can be seen in FIG. 6B that in total four of the light-emitting diodes 23 are arranged in the region of the circumference of the pressure element 14a and that the lines 24 together with the lines 15, which are connected with the piezo element 13, lead to the control circuit 25 shown in FIG. 6A. The light-emitting diodes 23 can be used in order to visually signal to the user that he or she has successfully actuated the specific action field 16. For this purpose the circuit sends an acknowledgement signal to the light-emitting diodes 23.

In this embodiment a press button is used as the pressure element 14a. This press button can be, for example, a cylindrical element made of glass. Between the pressure element and the top plate the joint is filled by the joint seal 18.

In a further embodiment a designation or structure is milled or etched into the pressure element 14, 14a, 14b, 14c. A numeral or a letter can, for example, be shown on the pressure element. This numeral or this letter is then visible and/or perceptible from outside by the user.

The milled-in or etched structure or designation can be filled with a special color in order to be excited by the light of the light-emitting diodes 23. The structure or the designation can thereby be illuminated quasi indirectly.

In a further embodiment of the present invention the piezo element 13 is so connected that the electrical energy produced by the pressing serves on the one hand for transmitting a signal to the circuit (in order to thus trigger an action) and on the other hand to supply one or more light-emitting diodes so as to give a direct optical acknowledgement. In this case the piezo element is used not only as a voltage source, but also as a charging source. A storage capacitance can be supplied by the charges produced and from there one or more light-emitting diodes can be supplied with current. In order to be able to control light-emitting diodes with the relative high voltage and low currents of a piezo element it is recommended to use a transformer which has in the secondary light-emitting diode circuit at a lower voltage, but a higher current.

If desired, a part of the layered construction is transparent, in which case glass is suitable as the top plate 11 and translucent films for the intermediate layers.

The laminated layered construction with glass plates as the top plate 11 and the base plate 12 has proved particularly satisfactory. A film with the piezo elements 13 and a film with the light-emitting diodes 23 can be laminated in place between these plates 11 and 12.

Preferably use is made of an electrical circuit which amplifies an output signal of a piezo element, if necessary, and further processes it.

Preferably there is used an electrical control circuit which is so designed that through application of an oppositely poled voltage (deactivation signal) one or more of the piezo elements contract. The action field 16 can thereby be temporarily deactivated, since either a mechanical coupling no longer exists between the corresponding piezo element 13 and the pressure element 14 seated thereabove or since the pressure element is retracted from the control panel 10 by the contraction of the piezo element 13. The same effect can also be achieved if the pressure elements 14 and piezo elements 13 are so designed that without the application of an activating voltage the pressure element does not protrude from the control field. Only when an activating voltage is applied by the circuit does the piezo element 13 expand and urge the pressure element 14 forwardly so that it is elevated in relation to the control panel.

The control panel 10 (10a, 10b, 10c, 10d) according to the present invention offers a direct correlation between an action (pressing of a button) and a reaction (tangible, audible and/or visible).

The control panel 10 (10a, 10b, 10c, 10d) according to the present invention is particularly flat and can be used independently of the substructure. The control panel 10 (10a, 10b, 10c, 10d) can be designed in optimum manner and thus satisfies the most diverse demands. It can be cleaned easily and without problems and is particularly vandal-proof.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A control panel for an elevator, wherein the control panel has at least one pressure-sensitive action field in order to trigger an action by pressing, comprising:
a top plate having an opening for the action field;
a base plate;
a piezo element positioned adjacent said opening and between said top plate and said base plate whereby pressing in the action field exerts a force on said piezo element and said piezo element generates an electrical output signal on lines adapted to be connected to a control circuit; and
acknowledgement means responsive to an electrical acknowledgement signal from the control circuit for producing a change recognizable at the control panel as an acknowledgement of the output signal.

2. The control panel according to claim 1 wherein said piezo element is responsive to said acknowledgement signal for producing a change of said piezo element which is detectable in the action field.

3. The control panel according to claim 1 including a pressure element positioned in the action field adjacent said piezo element.

4. The control panel according to claim 3 wherein said pressure element is a substantially cylindrical pressure element which is seated in said opening and acts directly or indirectly on said piezo element when said pressure element is pressed.

5. The control panel according to claim 1 wherein an adhesive film fixes said piezo element between said top plate and said base plate.

6. The control panel according to claim 1 including a film positioned between said top plate and said base plate.

7. The control panel according to claim 6 wherein said film is one of a PVB film and a cast resin layer.

8. The control panel according to claim 6 wherein said film has at least one integrated light-emitting diode and said at least one light-emitting diode delivers light through said top plate in response to said acknowledgement signal.

9. The control panel according to claim 8 wherein said film includes transparent conductor tracks for connecting said at least one light-emitting diode to the control circuit to receive said acknowledgment signal.

10. The control panel according to claim 1 wherein said top layer is formed of glass.

11. The control panel according to claim 1 wherein said piezo element is vapor-deposited on or glued to a carrier layer.

12. The control panel according to claim 1 including a plurality of the action field and one of said piezo element associated with each of the action fields.

13. An elevator with a control panel arranged in or at an elevator car of the elevator, the control panel comprising:
a top plate having an opening for an action field;
a base plate;
a piezo element positioned adjacent said opening and between said top plate and said base plate whereby pressing in said action field exerts a force on said piezo element and said piezo element generates an electrical output signal on lines connected to said piezo element; and
acknowledgement means responsive to an electrical acknowledgement signal for producing a change recognizable at the control panel as an acknowledgement of said output signal.

14. The elevator according to claim 13 including a control circuit connected to said lines to receive and process said output signal and to generate said acknowledgement signal.
